(19) United States
(12) Patent Application Publication
(10) Pub. No.: US 2013/0073575 A1
(43) Pub. Date: Mar. 21, 2013

(54) CROWD-SOURCED EXCLUSION OF SMALL MATCHES IN DIGITAL SIMILARITY DETECTION

(71) Applicants: John Hartman, Oakland, CA (US); Christian Storm, Richmond, CA (US); Timothy Fitz, Austin, TX (US); Jeffrey Lorton, San Francisco, CA (US); Kevin Karabian, Alameda, CA (US); Fred Moyer, San Francisco, CA (US)

(72) Inventors: John Hartman, Oakland, CA (US); Christian Storm, Richmond, CA (US); Timothy Fitz, Austin, TX (US); Jeffrey Lorton, San Francisco, CA (US); Kevin Karabian, Alameda, CA (US); Fred Moyer, San Francisco, CA (US)

(73) Assignee: IPARADIGMS, LLC, Oakland, CA (US)

(21) Appl. No.: 13/617,337

(22) Filed: Sep. 14, 2012

Related U.S. Application Data
(60) Provisional application No. 61/535,725, filed on Sep. 16, 2011.

(51) Int. Cl. G06F 17/30

(52) U.S. Cl. 707/757; 707/E17.005

(57) ABSTRACT

The present invention relates to systems that search documents and highlight occurrences of text found in previously published documents, publications, Internet websites and electronic documents. In particular, the present invention relates to originality assessment of a variety of documents (e.g., student papers, college admissions essays, PhD theses, magazines, newspapers, and book publications).

This application claims priority to provisional patent application Ser. No. 61/535,725, filed Sep. 16, 2011, which is herein incorporated by reference in its entirety.

### FIELD OF THE INVENTION

The present invention relates to systems that search documents and highlight occurrences of text found in previously published documents, publications, Internet websites and electronic documents. In particular, the present invention relates to originality assessment of a variety of documents (e.g., student papers, college admissions essays, PhD theses, magazines, newspapers, and book publications).

### BACKGROUND OF THE INVENTION

The Internet has permitted users with web browsers to easily exchange information. Material drawn from these sources is easily incorporated into written, original documents. Unless properly cited, such unoriginal material is considered plagiarism. The pervasiveness of the Internet in recent years has created a market for software services that automate the tedious process of checking documents for originality. The process of checking documents requires tuning to filter out common phrases that otherwise appears as “false-positive” matches in documents. By allowing users to identify common phrases a priori, the amount of “false-positive” detections presented to a user can be significantly reduced, thereby creating a more effective match detection service.

Without exclusion of common phrases in plagiarism detection, it is often the case that 2% to 10% of an original work may be flagged as unoriginal. This is particularly true in classroom assignments where entire classes of students each submit papers on the same subject. Modern detection services look for collusion among peers that results in identical material appearing in two or more assignment submissions.

Likewise, college admission essays often contain “prompt” text in the form of questions. Prompt text appears as matches in all submitted applications, compromising the efficacy of match reporting.

What are needed are improved methods to identify plagiarism, while excluding common, but not plagiarized, text.

### DESCRIPTION OF THE DRAWINGS

FIGS. 1a and 1b demonstrate an exemplary application of embodiments of the present invention. A single “prompt” of text in an essay is excluded from the generated similarity report. The amount of matched text drops from 100% to 93% due to the prompt text being excluded in the process. FIG. 1a shows a report without exclusion; FIG. 1b shows a report with text excluded.

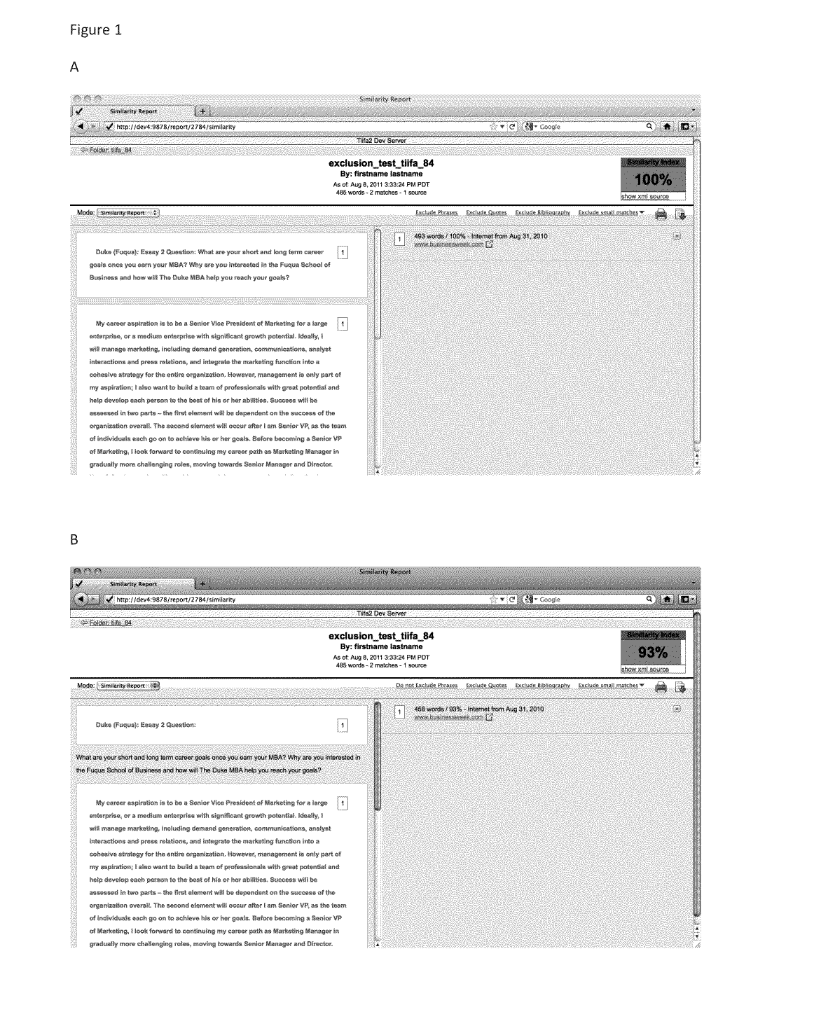

FIG. 2 shows a flow chart of processes in embodiments of the present invention.

### SUMMARY OF THE INVENTION

The present invention relates to systems that search documents and highlight occurrences of text found in previously published documents, publications, Internet websites and electronic documents. In particular, the present invention relates to originality assessment of a variety of documents (e.g., student papers, college admissions essays, PhD theses, magazines, newspapers, and book publications).

Embodiments of the present invention provide systems (e.g., computer systems) and methods for identifying repeated text in original works that is not plagiarized text. The systems and methods described herein decrease the noise and improve the efficiency of originality checking software in a variety of applications.

For example, in some embodiments the present invention provides systems and methods for document analysis, comprising a processor and software configured to generate an anti-source mask of a submitted original work by removing text (e.g., generated by receiving a plurality of undesired match text submitted by users; and generating a text exclusion hash of undesired matches from the undesired match text) from the submitted original work, and d) generate a similarity report of the submitted original work by identifying text in a match sources hash found in the submitted original work. In some embodiments, the document is pre-processed to mark phrases/text regions that are to be excluded. In some embodiments, the matches are post-processed to remove any matches to the phrases in an exclusion list. In some embodiments, text to be removed or excluded is identified by a text exclusion hash. In some embodiments, text to be removed or excluded is identified as individual strings of text separated by a character (e.g., null character). In some embodiments, the submitted original work is, for example, student papers, college admissions essays, PhD theses, magazines, newspapers, book publications or software code. In some embodiments, the systems and methods further comprise a processor and software configured to facilitate review or mark-up of the original work. In some embodiments, the plurality of undesired match text comprises 50, 100, 500, 1000, 10,000 or more text sections. In some embodiments, the software is configured for updating the text exclusion hash with new undesired match text (e.g., submitted by users utilizing the software and processor). In some embodiments, the system is further configured to display the similarity report.

Additional embodiments are described herein.

### Definitions

To facilitate an understanding of the present invention, a number of terms and phrases are defined below:

As used herein, the term “submitted original work” refers to a document (e.g., text document) written by one or more authors. In some embodiments, the document contains original text as well as cited material. In some embodiments, the “submitted original work” contains “match noise,” “match sources” or plagiarized text.

As used herein, the term “match sources” refers to a collection of works in text form whose substrings are of interest to a user during a “text detection search;” exemplary “match sources” are previously “submitted original works,” pages on Internet Web Sites, published books, published periodicals, and admissions essays. In some embodiments, “match sources” are plagiarized work.

As used herein, the term “match noise” refers to text in a “submitted original work” which is generally identified (e.g., by an individual, group, general consensus) as desired or unworthy of similarity matching in “match sources.”

As used herein, the term “hash” refers to a map of large data sets to smaller data sets performed by a hash function. For example, a single hash can serve as an index to an array of “match sources”. The values returned by a hash function are called hash values, hash codes, hash sums, checksums or simply hashes.

As used herein, the term “match sources hash” refers to a hash of all text comprising “match sources”; in some embodiments, the hash decomposes the text into a collection of permutations of substrings suitable for consumption in a “text detection search.”

As used herein, the term “text detection search” refers to a search process wherein occurrences of text in a “submitted original work” are identified in a larger body of source material; typically such searches involve exhaustive comparisons of text permutations and inexact or fuzzy matching.

As used herein, the term “anti-source mask of submitted original work” refers to a report generated by a “text detection search” that identifies regions of text in a “submitted original work” that contain “match noise” described by a given “text exclusion set.”

As used herein, the term “similarity report of submitted original work” refers to the result of a “text detection search.” In some embodiments, the report catalogs occurrences of text in the “submitted original work” located in source material.

As used herein, the term “text exclusion set” refers to a collection of texts; one or more contiguous strings of text; the length of the test strings are of arbitrary length, typically using the Unicode multi-byte character encoding. In some embodiments, the texts in the inclusion set have been identified as plagiarized work.

As used herein, the term “text exclusion hash” refers to an index or hash of all text comprising a “text exclusion set;” the hash decomposes the text into a collection of permutations of substrings suitable for consumption in a “text detection search.”

The term “system” is used to refer to a document management system (e.g., online). The term “database” is used to refer to a data structure for storing information for use by the system.

The term “user” refers to a person using the systems or methods of the present invention. The term “instructor” refers to a person teaching or otherwise providing content or instruction for an on-line educational system. A person may be both a user and an instructor.

As used herein, the terms “processor” and “central processing unit” or “CPU” are used interchangeably and refer to a device that is able to read a program from a computer memory (e.g., read only memory (ROM) or other computer memory) and perform a set of steps according to the program.

As used herein, the term “Internet” refers to any collection of networks using standard protocols. For example, the term includes a collection of interconnected (public and/or private) networks that are linked together by a set of standard protocols (such as TCP/IP, HTTP, and FTP) to form a global, distributed network. While this term is intended to refer to what is now commonly known as the Internet, it is also intended to encompass variations that may be made in the future, including changes and additions to existing standard protocols or integration with other media (e.g., television, radio, etc). The term is also intended to encompass non-public networks such as private (e.g., corporate) Intranets.

As used herein, the terms “World Wide Web” or “web” refer generally to both (i) a distributed collection of interlinked, user-viewable hypertext documents (commonly referred to as Web documents or Web pages) that are accessible via the Internet, and (ii) the client and server software components which provide user access to such documents using standardized Internet protocols. Currently, the primary standard protocol for allowing applications to locate and acquire Web documents is HTTP, and the Web pages are encoded using HTML. However, the terms “Web” and “World Wide Web” are intended to encompass future markup languages and transport protocols that may be used in place of (or in addition to) HTML and HTTP.

As used herein, the term “web site” refers to a computer system that serves informational content over a network using the standard protocols of the World Wide Web. Typically, a Web site corresponds to a particular Internet domain name and includes the content associated with a particular organization. As used herein, the term is generally intended to encompass both (i) the hardware/software server components that serve the informational content over the network, and (ii) the “back end” hardware/software components, including any non-standard or specialized components, that interact with the server components to perform services for Web site users.

As used herein, the term “in electronic communication” refers to electrical devices (e.g., computers, processors, etc.) that are configured to communicate with one another through direct or indirect signaling. For example, a conference bridge that is connected to a processor through a cable or wire, such that information can pass between the conference bridge and the processor, are in electronic communication with one another. Likewise, a computer configured to transmit (e.g., through cables, wires, infrared signals, telephone lines, etc) information to another computer or device, is in electronic communication with the other computer or device.

As used herein, the term “transmitting” refers to the movement of information (e.g., data) from one location to another (e.g., from one device to another) using any suitable means.

As used herein, the term “intermediary service provider” refers to an agent providing a forum for users to interact with each other (e.g., identify each other, make and receive assignments, etc). For example, an intermediary service provider may provide a forum for faculty members to create and distribute assignments to students in a class (e.g., by defining the assignment and setting dates for completion), or provide a forum for students to receive and respond to assignments such as peer review assignments. The intermediary service provider also allows, for example, users to maintain a portfolio of work submitted in response to all assignments for a particular class or project and for the collection of data (such as customized questions and rubrics) which can be used to supplement knowledge base data in a library of such data. In some embodiments, the intermediary service provider is a hosted electronic environment located on the Internet or World Wide Web.

As used herein, the term “client-server” refers to a model of interaction in a distributed system in which a program at one site sends a request to a program at another site and waits for a response. The requesting program is called the “client,” and the program which responds to the request is called the “server.” In the context of the World Wide Web (discussed below), the client is a “Web browser” (or simply “browser”) which runs on a computer of a user or another computer that sends HTML requests to the “server” (e.g., Web Services); the program which responds to browser requests by serving Web pages is commonly referred to as a “Web server.”

As used herein, the term “hosted electronic environment” refers to an electronic communication network accessible by computer for transferring information. One example includes, but is not limited to, a web site located on the World Wide Web.

### DETAILED DESCRIPTION OF THE INVENTION

The present invention relates to systems that search documents and highlight occurrences of text found in previously published documents, publications, Internet websites and electronic documents. In particular, the present invention relates to originality assessment of a variety of documents (e.g., student papers, college admissions essays, PhD theses, magazines, newspapers, and book publications).

The below description illustrates exemplary embodiments of the present invention in an education setting. However, the present invention is not limited to education settings. One of skill in the art recognizes that embodiments of the present invention find use in a variety of applications and industries. For example, in some embodiments, the systems and methods described herein are utilized to identify match noise in software source code.

Embodiments of the present invention provide users of a digital plagiarism detection service the ability to specify text exclusion sets comprised minimally of a collection of text strings or maximally up to entire crowd-sourced collection of text strings that are considered unimportant or undesired in the context of a text detection search (e.g., because they are not considered to be plagiarized work), thereby reducing match noise in a text detection search. For example, originality searches will sometimes identify common phrases as potential match sources (e.g., plagiarized work). However, these phrases (e.g., referred to herein as match noise) are not plagiarized work, but rather common phrases found in many texts. Thus, the systems and methods described herein avoid un-necessary screening of match phrases that are not relevant to an originality analysis. This saves reviewers time and resources and saves authors' time and reduces the stigma of having their work labeled as containing plagiarized text.

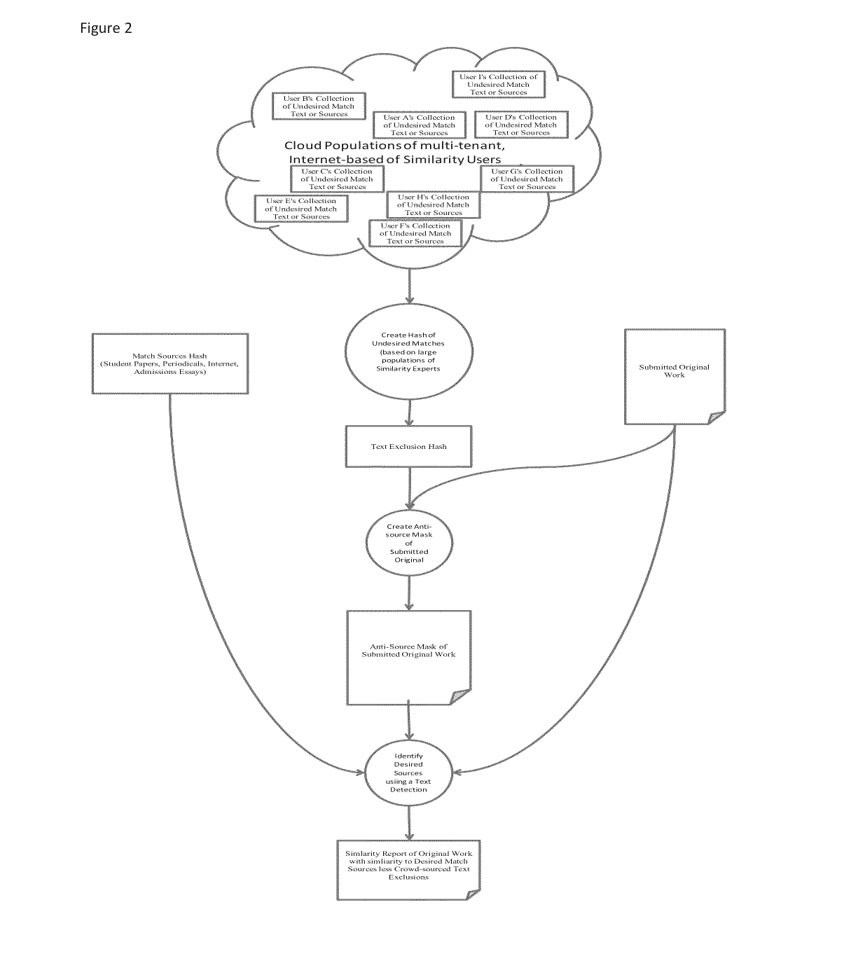

An overview of embodiments of the present invention is shown in FIG. 2. In some embodiments, a cloud population of a collection of users (e.g., users working in a similar academic or other area) are sourced to generate a collection of undesired match text or match sources. For example, in some embodiments, users submit common matches that are not plagiarized to a database. These may be selected from prior originality report false positives (e.g., prior false positives flagged as such by a user). It is generally preferred to obtain as large a sample size as possible to increase accuracy and number of undesired matches (e.g., 50, 100, 500, 1000, 10,000 or more samples). In some embodiments, users of originality analysis software are able to submit their undesired matches from within the software (e.g., by tagging a particular phrase as being an undesired match).

The present invention is not limited to a particular method of storing and retrieving text information. In some embodiments, text to be excluded is obtained by pre-processing the document to mark phrases/text regions that shouldn't be searched and/or post-processing the matches and remove any matches to the phrases in an exclusion list. Exemplary methods for storing and retrieving text (e.g., multiple phrases or strings of characters) to be excluded include but are not limited to, hashing the phrases for search and retrieval or storing the phrases as-is in text form (e.g., individual strings (e.g., phrases) are stored together and delimited from one another using a special character, e.g., null character).

In some embodiments, the crowd sourced undesired matches are then combined to generate a collection (e.g., hash) of undesired matches (e.g., text exclusion hash), although the present invention is not limited to the use of hashes to define excluded text or other collections of text. While certain embodiments of the invention are utilized with the use of hashes of text, other methods are also specifically contemplated. In some embodiments, the hash of undesired matches is continually refined and expanded based on additional submissions of undesired matches from users.

For example, as shown in FIG. 2, in some embodiments, a text detection search combines one or more text exclusion sets together to create a text exclusion hash. The user then submits their work (e.g., manuscript, student term paper or other academic assignment, software code, etc.). A matching algorithm then applies the text exclusion hash values to hash values of a submitted original work, creating an anti-source mask of submitted original work. The anti-source mask of submitted original work identifies areas of the submitted original work that contain regions of text that are excluded in a subsequent similarity searching (e.g., non-plagiarized text). Thus, common matches that are match noise are eliminated from future originality searches, thus reducing noise in the form of unwanted matches.

A matching algorithm is then used to match regions of the submitted original work that were not excluded in the anti-source mask of submitted original work to produce a similarity report of the submitted original work that contains references to the desired match sources less crowd-sourced match noise (e.g., regions of plagiarized or suspected plagiarized text). In some embodiments, a match sources hash is applied to the regions of the submitted original work to produce the similarity report, although the present invention is not limited to the use of hashes.

By allowing a population of users (e.g., users working in a particular field or industry) to collectively identify match noise in each of their submitted original works, collective, population-wide corpora of match noise are created. These corpora apply in various search contexts such as, but not limited to, similarity among papers submitted to an assignment, similarity among all papers submitted at a class, similarity among all papers submitted to a school, similarity among all papers submitted in a field of study, and all admissions essays submitted to colleges and universities.

The systems and methods described herein for identifying and reducing match noise find use in a variety of applications. In some embodiments, the algorithms are included in software programs used in originality analysis (e.g., including, but not limited to, Turnitin, iThenticate, WriteCheck (iParadigms, Oakland, Calif.)). Examples of originality checking software can be found, for example, in U.S. Pat. No. 7,219,301; herein incorporated by reference in its entirety.

In some embodiments, the systems and methods described herein are further configured to facility review (e.g., instructor or peer review) and contextual mark-up of submitted original work (See e.g., U.S. Pat. No. 7,703,000; herein incorporated by reference in its entirety).

In some embodiments, algorithms (e.g., integrated into originality checking software) are part of a computer system. In some embodiments, computer systems comprise a user interface operably connected to a computer processor in communication with computer memory. Computer memory can be used to store applications, along with a central data base including submitted original work, match databases and other data and applications. In some embodiments, access to the user interface is controlled through an intermediary service provider, such as, for example, a website offering a secure connection following entry of confidential identification indicia, such as a user ID and password, which can be checked against the list of subscribers stored in memory. Upon confirmation, the user is given access to the site. Alternatively, the user could provide user information to sign into a server which is owned by the customer and, upon verification of the user by the customer server, the user can be linked to the user interface.

The user interface can be used by a variety of users to perform different functions, depending upon the type of user. For purposes of embodiments of the present invention, there are generally at least three categories of users (although other users may also be defined and given access): sponsors, submitters, and reviewers. Sponsors are those who require or invite the submission of papers, and define the parameters of those papers, including content. In an academic environment, this category typically includes teachers or professors. Submitters are those who prepare and submit papers for review. In an academic environment, this typically includes students. Reviewers are those who review the submitted papers for quality, and for compliance with the parameters and criteria defined by the sponsor (e.g., originality). In an academic environment, reviewers can be the teacher or professor of the class for which the paper was submitted, other teachers or professors (e.g., members of a thesis or dissertation committee), or students. Indeed, the practice of having students exchange and grade tests and quizzes in class has been a common practice. While some embodiments of the present invention are carried out in an academic setting, one skilled in the art will recognize that the present invention can also be applied to a variety of other peer review situations, such as, for example, evaluating papers for publication, and reviewing grant proposals.

Users generally access the user interface by using a remote computer, internet appliance, or other electronic device with access to the internet and capable of linking to an intermediary service provider operating a designated website (such as, for example, turnitin.com) and logging in. Alternatively, if elements of the system are located on site at a customer's location or as part of a customer intranet, the user can access the interface by using any device connected to the customer server and capable of interacting with the customer server or intranet to provide and receive information.

In some embodiments, the steps of the process are carried out by the intermediary service provider, and the peer review, markup or originality report is generated and accessible to the sponsor through the user interface. However, some institutions may wish to maintain control over their students' papers. In such cases, it is possible to divide the processing between the customer's server and the intermediary service provider's server.

Various modifications and variations of the described method and system of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention that are obvious to those skilled in the relevant fields are intended to be within the scope of the present invention.

We claim:

1. A system for document analysis, comprising a processor and software configured a) generate a anti-source mask of a submitted original work by removing undesired match text from said submitted original work, and b) generate a similarity report of said submitted original work by identifying text in a match sources text found in said submitted original work.

2. The system of claim 1, wherein said undesired match text is stored and retrieved as a hash or as individual strings of text.

3. The system of claim 2, wherein said software is further configured to generate a text exclusion hash of removed text by the steps of a) receiving a plurality of undesired match text submitted by users; and b) generating a text exclusion hash of undesired matches from said plurality of undesired match text.

4. The system of claim 1, wherein said submitted original work is selected from the group consisting of student papers, college admissions essays, PhD theses, magazines, newspapers, book publications and software code.

5. The system of claim 1, wherein said system further comprises a processor and software configured to facilitate review or mark-up of said original work.

6. The system of claim 1, wherein said plurality of undesired match text comprises 50 or more text sections.

7. The system of claim 1, wherein said plurality of undesired match text comprises 1000 or more text sections.

8. The system of claim 1, wherein said plurality of undesired match text comprises 10,000 or more text sections.

9. The system of claim 3, wherein said software is configured for updating said text exclusion hash with new undesired match text.

10. The system of claim 1, wherein said system is further configured to display said similarity report.

11. A method for document analysis, comprising:
a) generating an anti-source mask of a submitted original work by removing undesired match text from said submitted original work; and
b) generating a similarity report of said submitted original work by identifying text in a match sources text found in said submitted original work.

12. The system of claim 11, wherein said undesired match text is stored and retrieved as a hash or as individual strings of text.

13. The method of claim 12, further comprising the step of generate a text exclusion hash of said removed text by a) inputting a plurality of undesired match texts from users into a computer processor comprising computer software; and b) generating a text exclusion hash from said plurality of undesired match text.

14. The method of claim 11, wherein said submitted original work is selected from the group consisting of student papers, college admissions essays, PhD theses, magazines, newspapers, book publications and software code.

15. The method of claim 11, wherein said method further comprises review or mark-up of said original work.

16. The method of claim 11, wherein said plurality of undesired match text comprises 50 or more text sections.

17. The method of claim 11, wherein said plurality of undesired match text comprises 1000 or more text sections.

18. The method of claim 11, wherein said plurality of undesired match text comprises 10,000 or more text sections.

19. The method of claim 12, further comprising the step of updating said text exclusion hash with new undesired match text.

20. The method of claim 11, further comprising the step of displaying said similarity report.
